(19) United States
(12) Patent Application Publication
(10) Pub. No.: US 2008/0133647 A1
(43) Pub. Date: Jun. 5, 2008

(54) System and method for delivering web content to a mobile network

(76) Inventor: Mehrak Hamzeh, Encinitas, CA (US)

Correspondence Address: MINTZ, LEVIN, COHN, FERRIS, GLOVSKY AND POPEO, P.C;ATTN: PATENT INTAKE CUSTOMER NO. 64046, ONE FINANCIAL CENTER, BOSTON, MA, 02111, US

(21) Appl. No.: 11/986,320

(22) Filed: Nov. 19, 2007

Related U.S. Application Data
(60) Provisional application No. 60/859,736, filed on Nov. 17, 2006.

(51) Int. Cl. G06F 15/173

(52) U.S. Cl. 709/202; 709/218

(57) ABSTRACT

Systems and methods for the distribution and delivery of digital web content using a wireless network. The systems and methods can include relationships with web content aggregators to ensure the successful delivery of content to wireless carriers worldwide. In one aspect, mobile media applications are presented by which content producers and owners distribute digital media and information directly to cell phones from websites, creating a new source of revenue for content producers and reallocates carrier revenue to the content owners. The end users of this digital media become part of a mobile community and receive valuable information and services over their cell phones.

### CROSS REFERENCE TO RELATED APPLICATION

The present patent application claims priority under 35 U.S.C. §119 to U.S. Provisional Patent Application Ser. No. 60/859,736, filed on Nov. 17, 2006, and entitled, “System and Method For Distribution of Web Content On A Mobile Network”, the entire disclosure of which is incorporated by reference herein.

### BACKGROUND

This disclosure relates generally to wireless communications, and more particularly to methods, systems and techniques to deliver web content and other digital media from a website to a mobile device.

Cell phone use is now ubiquitous in many countries, and an amount of services available to cell phones continues to rapidly expand. Indeed, cell phone users now use their mobile devices to shop, browse the web, conduct business, and check their email or other messages. One issue for mobile web content is that paradoxically, the main enablers of such growth of the types and amount of web content that is currently being pushed to cell phones, the wireless carriers—those companies that have built and now run the world's wireless communication networks—are the same parties that may strictly control the web content that can be transmitted through their networks. The carriers may severely limit the web content that users may download from websites.

Another issue is the type or format of web content that can be distributed to mobile devices. A website is typically hosted on a server and contains content that is downloadable to a browser application on a client computer. A mobile device can include a mobile browser that is specifically adapted for downloading only web content that has been formatted specifically for the limited scales of mobile device displays. Further, there is no gateway currently between mobile devices the web content delivered to client computers through standard web browsing.

### SUMMARY

In general, this document discusses systems and methods for distribution and delivery of digital web content using a wireless network.

The systems and methods can include relationships with web content aggregators to ensure the successful delivery of content to wireless carriers worldwide. In one aspect, mobile media applications are presented by which content producers and owners distribute digital media and information directly to cell phones, creating a new source of revenue for content producers and reallocates carrier revenue to the content owners. The end users of this digital media become part of a mobile community and receive valuable information and services over their cell phones.

In a related aspect, a method includes sending selected web content via a wireless network to one or more designated mobile devices in response to a user input, via a client computer, to a webpage that contains the selected content and that has been downloaded to the client computer from a server system.

In a related aspect, a mobile media system includes an interface to a wireless communication network. The system further includes a client application suite in a client computer that receives web content from a website, the client application suite comprising a content wrapper to wrap content from the website for distribution to the wireless communication network, and a content-to-mobile code module that sends the wrapped content to the wireless network interface for distribution to one or more designated mobile devices connected to the wireless communication network.

In yet another related aspect, a method for distributing web content to one or more mobile devices connected to a wireless communication network includes providing a window in a webpage that has been downloaded from a server, the window being associated with web content in the webpage, and further being adapted to receive at least a number of at least one of the one or more mobile devices to which the associated web content is to be sent. The method further includes sending the web content to the at least one of the one or more mobile devices based on the number received in the window.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 is a functional block diagram of a mobile media system for delivering web content to a mobile network.

FIG. 2 illustrates a content wrapper that is provided in a webpage of a website.

FIG. 3 illustrates a text-to-mobile messenger software module.

FIG. 4 illustrates a combination of mobile media system components in an invitation website context.

Like reference symbols in the various drawings indicate like elements.

### DETAILED DESCRIPTION

This document describes systems and methods for efficiently transferring digital content between websites and mobile devices, and specifically systems and methods for distribution of digital content from websites to mobile phones, independent of carrier portals, to enabling fully interactive mobile communities. In some implementations, a system includes a software application that is executable locally within a client computer in conjunction with a browser application. One type of software application “wraps” selected content in a proprietary code wrapper, which then transmits the selected wrapped content to the Internet and to a wireless communication network, and eventually to a designated mobile device.

At the mobile device, the selected content is unwrapped and displayed to a user of the mobile device. Content that can be selected includes text, images, video, and audio. Accordingly, the system enables content providers to distribute their content directly, or via visitors to web pages that include the content, without the limitations of the wireless carriers' networks. Further, content owners and rights holders experience significantly less complexity from the standpoint of distribution and cash flow. Products are sold directly from an existing web site, and money can be collected in a timely manner.

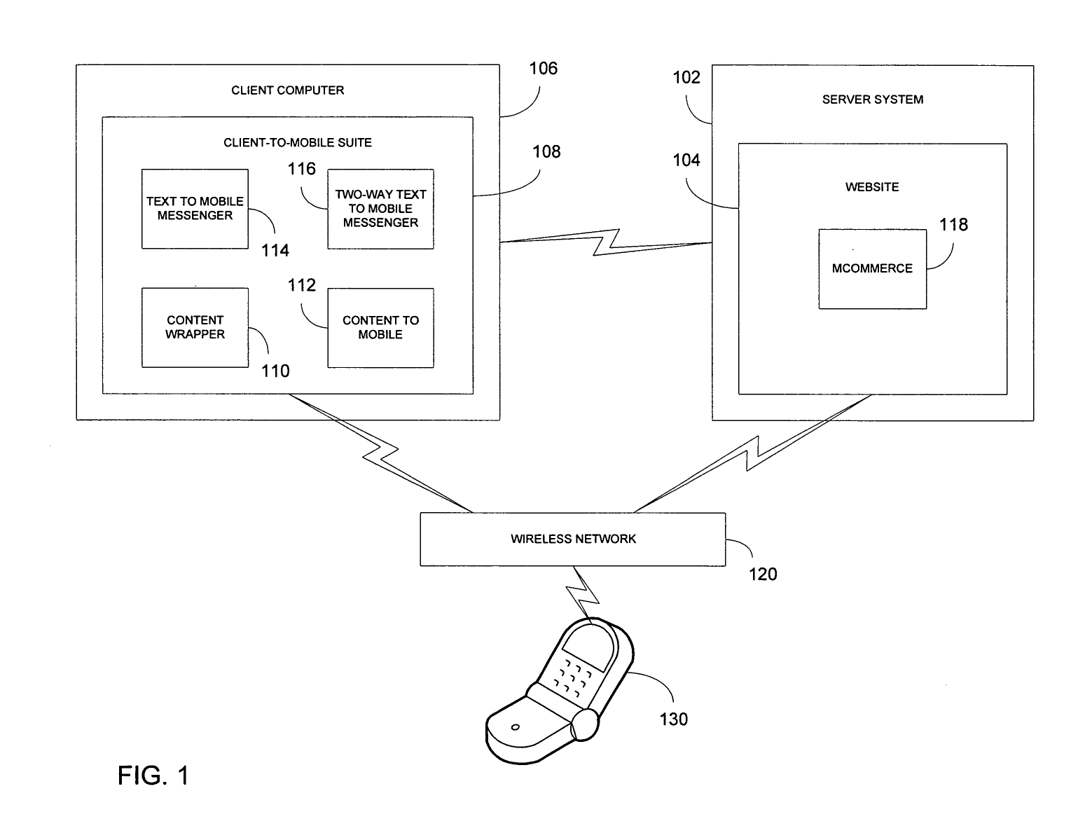

FIG. 1 is a functional block diagram of a mobile media system 100 for delivering web content to a mobile network. The mobile media system 100 includes a server system 102 that downloads web content in a website 104 to one or more client computers 106 in response to requests from the a client computer 106. The website 104 can contain digital text, images, video, or audio content, or any combination thereof, and can be any website or even a “hosted webpage,” e.g. a webpage that is created from a webpage template and hosted by the system 100. The web content can be provided to the client computer 106 in any format, such as HTML (HyperText Transfer Protocol) or XML (eXtensible Markup Language). The client computer 106 includes a client-to-mobile suite 108, that can be integrated into a web browser application or can be an independent local application, for communicating digital media content via wireless network 120 to one or more mobile devices 130.

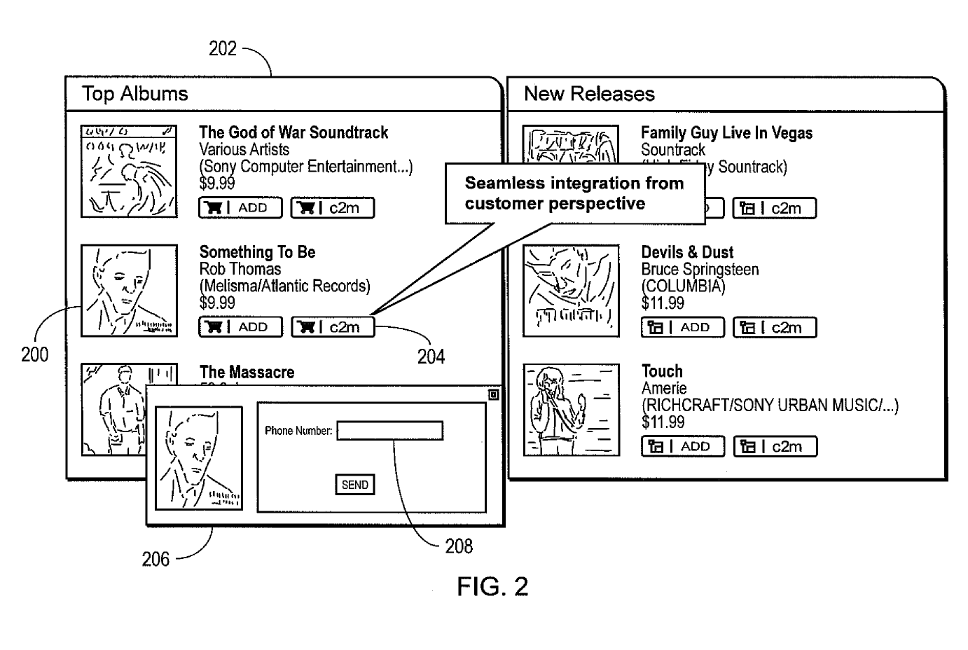

The client-to-mobile suite 108 includes content wrapper 110. The content wrapper 110 is a plug-and-play application that “wraps” any content, i.e. image, MP3 (Moving Pictures Experts Group Audio Layer 3) file, video, text, etc., for client's with existing media, site infrastructure and GUI (graphical user interface), and adds content to mobile 112 for mobile distribution without altering the existing site structure. As shown in FIG. 2, the content wrapper 110 enables any content 200 that is provided in a website 202, to be associated with a click-to-mobile function 204 for transmitting the content 200 directly to any desired mobile device. The click-to-mobile function 204 can be the result of user input, such as a right-click of a mouse, or can be displayed for selection automatically in the website 202. In some implementations, a small window 206 appears near the content 200, and includes an input block 208 for a user to input a mobile device number of a desired recipient. Once the number is entered, the user selects “send” and the content 200 is automatically sent to the desired recipient.

The content wrapper 110 can be used in a number of scenarios, such as website syndication (in which a content producer has a site infrastructure but needs a media-oriented website template that is tailored for mobile distribution), web page hosting (in which a content producer has no website, or private label WAP (Wireless Application Protocol) site (in which a content producer can utilize one or more webpage templates provided by the client-to-mobile suite 108) that is applicable to a wide variety of markets including sports, entertainment, politics, finance, and social networks, to name a few. The client-to-mobile suite 108 includes pre-designed webpage templates, into which content and media can be instantly imported. These webpage templates can include templates for GUIs, and can generate unique URLs (Uniform Resource Locators) that designate the webpage as mobile media compatible.

In a particular implementation, associated with website syndication, a user can use an upload tool in the client-to-mobile suite 108 to manage all discrete pieces of content, individually or via an XML feed for dynamic, high volume upload. The uploaded images can be automatically updated using an administration tool, and with a pre-designed webpage template, a website GUI can be created to generate dynamic content pages.

The hosted web page provides users, through the web-based administrative tools, with functions to host and manage all development, of mobile media, including an entire billing management infrastructure. Further, a set of analytical tools provides users with real-time data regarding mobile media, transmissions from webpages to mobile devices (as well as responses from the mobile devices) and customer-specific business intelligence information.

The client-to-mobile suite 108 further includes a text-to-mobile messenger 114 and a two-way text-to-mobile messenger 116. The text-to-mobile messenger 114 enables a user to send a text message to any mobile device from a messaging box or drop down on any website, while the two-way text-to-mobile messenger 116 enables a user to send a text message from any website to any mobile device, and then receive a reply from that mobile device back at the website.

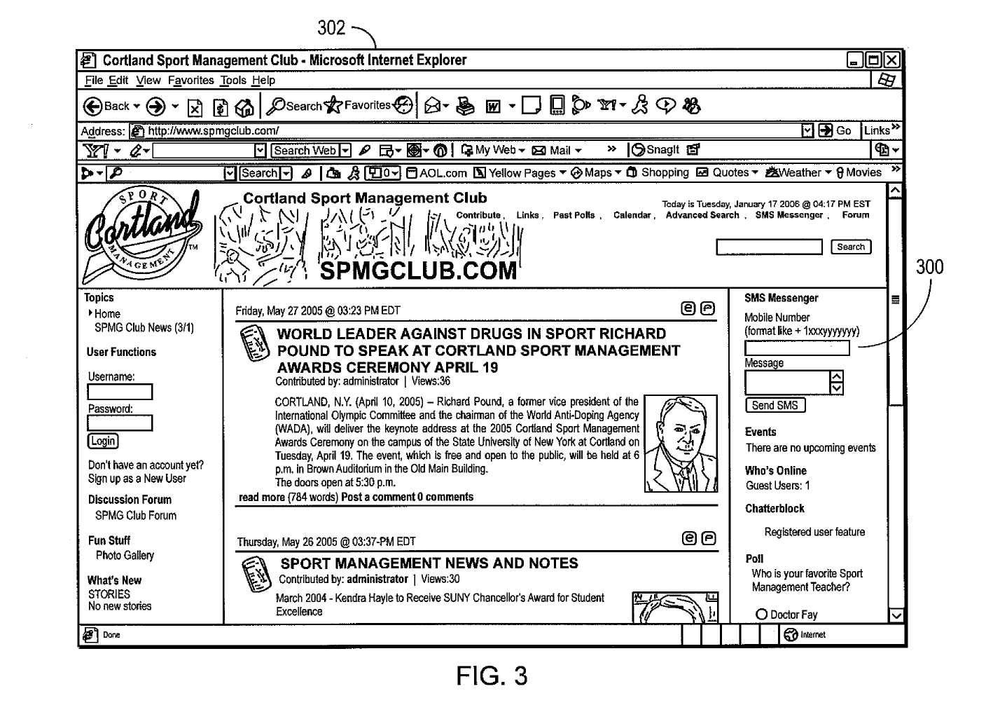

FIG. 3 illustrates the text-to-mobile messenger 114. A messaging window 300 is automatically placed within a webpage 302 of a website. To send a message directly from the webpage 302, the user types in a mobile device number in a first field, enters in the message information in a second field, and hits “send.” The message information is then transmitted directly to a mobile device user associated with the mobile device number. If the two-way text-to-mobile messenger 116 is used, the recipient of a message can interactively return messages to the webpage 302 being viewed by the user, so that a two-way messaging communication session can be executed. All text messages transmitted between the webpage 302 and a mobile device can be tracked so advertising sponsors may be placed into the transmission and pay the website owner for every text message sent from that website to a cell phone. For each website owner that signs up for the service, demographic data on that person may be obtained so that advertiser sponsors may be targeted for message transmission.

The content-to-mobile 112 can execute a number of different applications and features, including voice-text-to-mobile, which enables the combination of a voice call and text message to be sent to a mobile device, and video-to-mobile, which enables anyone to send “vidlets”, “mobisodes” or short advertisement clips from the Web to any mobile device. This feature can be an automated or triggered event to be sent at customer specific times. The content-to-mobile 112 can also enable the sending of ring tones or MP3 files to any mobile device. Other content that can be sent by the content-to-mobile in a like manner include pre-recorded voice messages for broadcast to a selected group of mobile devices, wallpaper for mobile device displays, other mobile-oriented applications such as mapping software, and other content. Yet another application includes enabling any business or consumer to upload an image and/or text message, and broadcast to multiple mobile devices simultaneously. An opt-in policy can be instituted to protect against spam on the mobile devices.

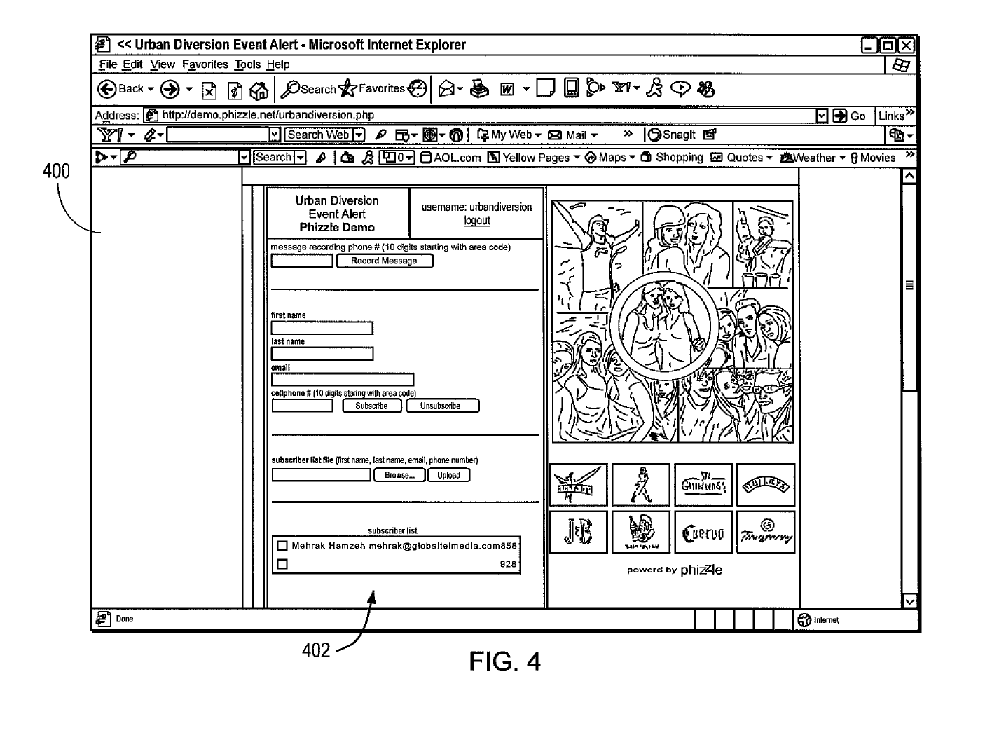

FIG. 4 illustrates a combination of some of the mobile media system 100 components, in an invitation website context. An invitation website 400 can be provided with a mobile media gateway 402, which can be a drop down or extra window, or even a portion of a webpage itself. The mobile media gateway 402 enables a user to include any number of mobile device numbers associated with intended recipients of an invitation. The mobile media gateway 402 further includes a record button to allow a user to record a voice file for sending to the selected mobile devices, a text window for entering text to be sent to the recipients, and an opt-in, opt-out option for potentially triggering the two-way text-to-mobile messenger 116. Lastly, an array of icons, each representing a sponsor, can be selected to sponsor the invitation. The user can get special subsidies for selecting a sponsor, and the sponsor may pay for some of the transaction costs of the invitation.

The “pick-a-sponsor” array may included in any mobile media system 100 function, and can be used to allow a user to select one of a number of willing commercial sponsors for the transaction. The willing sponsors can be determined by the content being sent to the mobile device, by recipient (i.e. number and/or type) or mobile device number (in which case at least some demographic or biometric information is known or can be determined for the recipient), or by the website that is accessed in order to create the content delivery scheme.

Referring back to FIG. 1, the website 104 of the server system 102 can include a mobile commerce module 118. The mobile commerce module 118 can communicate directly with designated mobile devices, for push-based and interactive commerce execution. For example, if a product becomes available that a mobile device user is interested in, the user can be set up to receive media-rich notifications, on their mobile device directly from the website, of the product offering and availability. The user can also send a reply to the website to conduct commerce, i.e. pressing a button to buy the product immediately, or another button to reject the offer by the commercial website.

In another example, a user of a client computer's browser may suddenly come across an item they would like to purchase it. That user can use the content wrapper 110 to send media content to a mobile device that describes the item. A positive reply by the user of the mobile device can trigger the automated commercial transaction with the mobile commerce module 118 as described above. Accordingly, all of the transactions can be done through the mobile device, and the user of the mobile device need not provide any credit card information or have to get to a client computer in order to execute the commerce.

The mobile commerce module 118 and any other functional module can be delivered to the server system 102 or client computer 106 by a mobile media server (not shown). The mobile media server can act as the primary gateway between the web content and the mobile device 130, and can interface with the wireless network 120.

The following exhibits three exemplary implementations of features and functionality that are used: a premium content model (as exemplified by a professional sports team); a viral consumer model (as exemplified by a social networking or blogging website); and an enterprise model (as exemplified by an online auctioning company).

A use case for a professional sports team can be exemplified as follows: A surplus of tickets become available 30 minutes before each home game. The franchise ticket sales office would like to offer these tickets to a targeted group, but does not have the time and resources to reach each person in the targeted group. Email is largely ineffective because most email messages are received while the recipient is at home in front of their computer, and calling each individual in the targeted group can be time and resource intensive.

The mobile media system 100 enables a purchasing mechanism for cell phone owners associated with the professional sports team. The system can also send a group voicemail message to an entire targeted group to let them know tickets are available for purchase (this may consist of multiple segments within the group). A user can also receive news and updates, fan club updates, sports alerts, trivia, tips, etc, as voice calls and/or messages, or “elite messages” in which Players and/or Coaches send messages or voice calls to subscribers with the above mentioned information. These calls are part of game day events, contests and fund-raising activities.

A use case for a social networking or blogging site can be exemplified as follows: A social website has 30 million members, each with their own website. The mobile media system can be used to coordinate events, parties, last minute venue changes etc., with a need to connect with other members when traveling. In a particular example, each member site can include an opt-in service, in which the members can invite friends to movies or social events. The delivery of the voice call and text message can be sponsored by a transmission sponsor. This solution enables other services such as the content wrapper 110 and content-to-mobile 112.

A use case for an auction site can be exemplified as follows: During an auction, if a buyer gets outbid they are notified to their email an invited to increase their bid, but if the buyer is not at their computer and they do not respond to email then they lose the auction, which results in lost sales and unhappy buyers. The mobile media system can be used to notify potential buyers via their mobile devices, and enables them to increase their bid directly from their mobile devices, preferably with a simple user interface. This may increase sales and buyer satisfaction.

Revenue can be generated through transmission sponsors, a premium content subscription model, direct advertising, and activations. In one model, a sponsor or advertiser pays for the delivery of calls, text messages, and all other digital content delivery. In exchange, the advertiser receives a fixed allotment of time to attach an advertising pitch to each call or message and a mobile coupon. With live calls, the advertiser or sponsor is also able to prompt the subscriber to request more information by pressing a number on the keypad. Through this model, subscribers receive their requested content for free.

There are two implementation types: Business to consumer (B2C) and business to business (B2B). The following illustrates steps in a B2C solution whereby a user is enabled to set up a wallpaper and ring tone storefront. The set up and deployment may take about ten minutes.

1. Sign up for service from www.globaltelmedia.com Web site.

2. Upload pictures and/or ring tones to hosted site or select from existing gallery of pictures or ring tones.

3. Price the mobile media for set-up to sell from the store.

4. The payment and billing system automatically debits and credits the appropriate storefront account.

5. Personalize the storefront with appropriate logos.

6. Link the storefront (i.e. www.globaltelmedia.com/apple) to existing website to start selling wallpaper and ring tones.

The following illustrates steps in a B2B solution, enabling an enterprise customer. The enterprise can either sell mobile media sell media for profit or give away mobile media (wallpaper and ring tones) for branding and customer loyalty purposes. The enterprise can also enable their customers to create their own storefronts to sell wallpaper and ring tones. Depending on which choice is selected a different deployment applies.

Option 1: Enterprise Storefront:

1. Select all media to be enabled from Web site.

2. Decide whether to enable content in its existing state as-is on website (recommended for branding) or create a new section of website dedicated solely for mobile media (one day to one week, depending on a customer response to move ahead).

3. If enabling media in existing state for mobile branding purposes, then the mobile media system issues gateway access for mobile media delivery and issues content wrapper code for customer installation. Customers can be billed monthly on net 30 terms for all content sent from their Web site to any cell phone.

4. If a new section of Web site is dedicated to mobile media, then determine whether or not customer wants their customers to be logged into their Web site to make purchase.

5. A web server web service connection gives fields necessary to facilitate registration/sign up if wanted, organize and display fields for mobile media, payment and billing.

6. Customer can select from templates on how to display their new mobile offering or create their own.

7. Get payment/billing gateway info from enterprise.

8. Test.

9. Launch.

Option 2: Community Member Storefronts:

1. Demonstrate hosted environment solution.

2. Enterprise selects what features they want to offer.

3. Use Web Services to connect up.

4. Set rules for community payout commissions.

5. Get payment/billing gateway info from enterprise.

6. Test the system.

7. Launch.

Implementations of these systems and methods, and all of the functional operations described in this specification, can be implemented in digital electronic circuitry, or in computer software, firmware, or hardware, including the structures disclosed in this specification and their structural equivalents, or in combinations of them. Embodiments can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments of the invention have been described. Other embodiments are within the scope of the following claims. For example, the steps recited in the claims can be performed in a different order and still achieve desirable results.

What is claimed:

1. A method comprising:
sending selected web content via a wireless network to one or more designated mobile devices in response to a user input, via a client computer, to a webpage that contains the selected content and that has been downloaded to the client computer from a server system.

2. The method of claim 1, further comprising providing, on the webpage, a content wrapper window in which a user can designate the one or more designated mobile devices.

3. The method of claim 2, further comprising wrapping the selected web content in content wrapper code to extract information about the selected web content for sending the selected web content.

4. The method of claim 1, further comprising downloading the webpage from the server system to the client computer.

5. The method of claim 1, wherein the selected web content includes text that has been entered into the website by a user via the user input.

6. The method of claim 1, wherein the selected web content includes images that are embedded in the webpage.

7. The method of claim 6, wherein the images have been transferred from a second webpage to the webpage.

8. The method of claim 1, wherein the selected web content includes further web content that is linked to by the selected web content.

9. The method of claim 1, further comprising receiving, in response to the sent selected web content, a response message from at least one of the one or more designated mobile devices.

10. The method of claim 9, further comprising executing an action that is represented by the response message from the at least one of the one or more designated mobile devices.

11. A mobile media system comprising:
an interface to a wireless communication network; and
a client application suite in a client computer that receives web content from a website, the client application suite comprising a content wrapper to wrap content from the website for distribution to the wireless communication network, and a content-to-mobile code module that sends the wrapped content to the wireless network interface for distribution to one or more designated mobile devices connected to the wireless communication network.

12. The system of claim 11, wherein the client application suite further comprises a text-to-mobile messenger adapted to transmit text that is entered into the website from a client computer to the one or more designated mobile devices.

13. The system of claim 11, wherein the web content includes digital images embedded in the website.

14. The system of claim 11, wherein the web content includes video embedded in or linked to by the website.

15. The system of claim 12, wherein the text-to-mobile messenger enables two-way messaging between the client computer and the one or more designated mobile devices.

16. A method for distributing web content to one or more mobile devices connected to a wireless communication network, the method comprising:
providing a window in a webpage that has been downloaded from a server, the window being associated with web content in the webpage, and further being adapted to receive at least a number of at least one of the one or more mobile devices to which the associated web content is to be sent; and
sending the web content to the at least one of the one or more mobile devices based on the number received in the window.

17. The method of claim 16, wherein the window is automatically associated with the web content in the webpage.

18. The method of claim 16, wherein the window is further adapted to receive a text message for transmission to the at least one of the one or more mobile devices.

19. The method of claim 16, wherein sending the web content further includes sending a client identifier associated with the window.

20. The method of claim 19, further comprising receiving, from the at least one of the one or more mobile devices, a reply message at a client computer associated with the client identifier.
